(19) United States
(12) Patent Application Publication
(10) Pub. No.: US 2011/0187095 A1
(43) Pub. Date: Aug. 4, 2011

(54) CLASSIFYING AND DISCRIMINATING AN ITEM OF CURRENCY BASED ON THE ITEM'S SPECTRAL RESPONSE

(75) Inventor: Fatiha Anouar, Glenmoore, PA (US)

(73) Assignee: MEI, Inc., West Chester, PA (US)

(21) Appl. No.: 13/055,687

(22) PCT Filed: Jul. 29, 2009
(86) PCT No.: PCT/US09/52099

§ 371 Date: Apr. 8, 2011

Related U.S. Application Data
(60) Provisional application No. 61/137,386, filed on Jul. 29, 2008.

(51) Int. Cl. B42D 15/00; G01J 3/50

(52) U.S. Cl. 283/70; 356/402

(57) ABSTRACT

An unknown item of currency is compared to at least one known item of currency by evaluating the spectral response of the unknown item of currency. A spectral response is obtained from the unknown item of currency, and the spectral response of the unknown item of currency is separated into a first component and a second component. At least one component of the spectral response of the unknown item of currency is compared to at least one component of the spectral response of at least one known item of currency having a specific denomination. A determination is made as to whether the unknown item on currency is a member of the class of the at least one known item of currency.

### CROSS-REFERENCE TO RELATED APPLICATION

This application claims the benefit of priority of U.S. Provisional Patent Application Ser. No. 61/137,386, filed on Jul. 29, 2008, the contents of which are incorporated herein in their entirety.

### FIELD OF THE DISCLOSURE

The disclosure relates to classifying items of currency and, in particular, to classifying an item of currency based on the spectral response of the item.

### BACKGROUND

Color is often used in the production of items of currency in order to differentiate one item of currency from another. For example, valuable documents often include printed patterns or pictures along with various other features that are made up of specific colored inks. For the purposes of the disclosure, valuable documents include, but are not limited to, banknotes, bills, notes, security documents, checks, certificates and coupons. A given currency may have many different denominations (e.g., 5 Euro, 10 Euro, 20 Euro and 50 Euro) of banknotes. Each denomination for a particular currency often has a unique image (often different for each face of the banknote) that is printed using a wide variety of colors.

In automated transaction devices (e.g., vending machines), a validation unit is provided and adapted for irradiating an inserted banknote with light (e.g., in at least one wavelength) and evaluating the spectral response of the inserted banknote. The spectral response information obtained by the validation unit can be used to identify certain features, inks, or patterns printed thereon. Typically, the validation unit uses the spectral response information to discriminate between genuine banknotes and non-genuine banknotes. Discrimination of the inserted banknote is often accomplished by matching the spectral response information of the inserted banknote to that of a group of reference banknotes indicative of different denominations and or currencies.

A limitation of some discrimination techniques relying on color results from that fact that colors can be represented by a vast number of different spectra. More particularly, a copy of an original banknote using equipment other than that used to produce the original banknote may be formed using a different combination of standard colors. Therefore colors perceived to be the same by the human eye can have different spectral responses.

### SUMMARY

The disclosure relates to discriminating items of currency. For the purposes of the disclosure an item of currency includes, but is not limited to, valuable documents, banknotes, bills, checks, coins, coupons, security documents or any other item of currency (genuine or non-genuine) used in exchange for goods or services. The disclosure describes a method and apparatus for discriminating items of currency based on a comparison of the spectral response of an unknown item of currency to at least one known item of currency.

In some implementations, a validation unit is provided for discriminating between items of currency. In particular, spectral response information for at least one reference item of currency (e.g., a first class) is stored within the validation unit and used for comparison with inserted items of currency. The validation unit is adapted to obtain spectral response information (e.g., based on reflection or transmission of light in at least one wave length) from an inserted item of currency. The validation unit can be further configured to use the measured spectral response of an item of currency and compare it with spectral response of at least one item of currency stored within the validation unit. The validation unit can be arranged to convert the measured response of an inserted item of currency into at least one component response. In some implementations, the at least one spectral component response is projected into a known standard color space. In some implementations, the measured spectral response of an inserted item of currency is projected into a color space and a further space orthogonal to the particular color space.

The measured spectral component responses of an inserted item of currency can be used with the spectral component responses of at least one known item of currency (i.e., a class of currency) as inputs into a classification technique for classifying the inserted item of currency.

Various aspects of the invention are set forth in the claims. Other features and advantages will be readily apparent from the detailed description and the accompanying drawings.

### BRIEF DESCRIPTION OF THE DRAWINGS

FIG. 1 illustrates an XY chromaticity diagram.

FIG. 2 illustrates a L*a*b* space diagram.

FIG. 3 illustrates various color gamuts.

FIG. 4 illustrates an example of a spectral response and associated component responses.

FIG. 5 illustrates a space that is orthogonal to a particular color space.

FIG. 6 illustrates the spectral response of a color in both the color space and the orthogonal space.

FIG. 7 illustrates the spectral response of a color perceived to be the same as the color of FIG. 6, but having a different response in the orthogonal space.

FIG. 8 illustrates a comparison of a genuine item of currency and a non-genuine item of currency in a color space, where both items have printed colors perceived to be the same in the color space.

FIG. 9 illustrates a comparison of a genuine item of currency and a non-genuine item of currency in a space orthogonal to a color space, where both items have printed colors perceived to be the same in the color space.

FIG. 10 is a block diagram showing an example of an automated transaction machine with a currency validation unit according to the invention.

FIG. 11 is a flow chart showing an example of a method for comparing an unknown item of currency to a known item of currency by evaluating the spectral response of the unknown item of currency.

### DETAILED DESCRIPTION

In some implementations, differences in colors present on an item of currency are used to discriminate one item of currency from another. In particular, color evaluation can be used to determine if an unknown item of currency has color similar to the color present on a known item of currency. In some implementations, a method for classifying unknown items of currency from known items includes comparing the spectral response of the known item of currency to the spectral response of the unknown item of currency. In other implementations, a validation unit is provided for discriminating known items of currency from unknown items of currency.

A validation unit includes a memory unit, a processing unit (e.g., a microprocessor) and a sensing unit. The sensing unit is adapted to obtain spectral response information from an item of currency using at least one light source and at least one sensor for sensing the spectral response of an item of currency in at least one wavelength. Items of currency are irradiated by the light source and spectral response information (e.g., based on reflectance or transmission) is obtained using the at least one sensor.

In some implementations, color can be described by the human visual perception of color, known as tristimulus thoery. Tristimulus theory involves the linear combination of three different photoreceptor types with known spectral sensitivities in the visible range. The International Commission on Illumination (CIE) has characterized the standard human visual color perception with color matching functions for a standard observer and defined color spaces. Examples of standard color spaces include, but are not limited to, the CIE XYZ and CIELAB spaces. These standards are fundamental for the science of colorimetry and for the transformation and sharing of color information. The application of colorimetry allows for an improved ability to discriminate between unknown items of currency and known items of currency. More specifically, the discrimination of genuine items of currency from non-genuine items of currency can be improved using various techniques of colorimetry.

Color input devices such as cameras and scanners that seek for colorimetric color reproduction (including color appearance match) of object colors must take into account the characteristics of the human visual system in their design and in the understanding of the output data from the physical sensors.

Light is composed of the whole spectra and therefore, color is a function of the whole light spectra. The trichromacy of color sensation leads to the metamerism phenomena. This means that different spectra can produce the same color. Since items of currency often have at least one color contained thereon, being able to discriminate between a color having been reproduced by a different spectra and a present color of a genuine item of currency becomes inherently important.

The properties of the human visual system are defined by the spectral responses of three cone types. The L cones have a peak response at about 570 nm. The M cones have a peak response at about 540 nm. The S cones have a peak response at about 445 nm. Using the CIE color matching functions x̅(λ), y̅(λ), z̅(λ), the linear relationship between the eye spectral sensitivities and the color matching functions can be given by:

$$[ \begin{matrix}X \\ Y \\ Z\end{matrix} ] = [ \begin{matrix}1. 9023 & - 1. 4000 & 0. 3544 \\ 0. 6371 & 0. 3933 & - 0. 0093 \\ 0. 0007 & 0. 0033 & 1. 7462\end{matrix} ] [ \begin{matrix}L \\ M \\ S\end{matrix} ]$$

The spectral power of a light source E is multiplied by the spectral reflectance of the object surface R. The result is the object color received by the observer. Assuming that the measurements are taken over the visible range from 400 nm to 780 nm with a step of 10 nm. The tristimulis space is defined by capital X,Y,Z given by

$$X = k {\sum }_{λ = 400}^{780} \overline{x} ( λ ) E ( λ ) R ( λ )$$

$$Y = k {\sum }_{λ = 400}^{780} \overline{y} ( λ ) E ( λ ) R ( λ )$$

$$Z = k {\sum }_{λ = 400}^{780} \overline{z} ( λ ) E ( λ ) R ( λ )$$

where k is a normalization factor:

$$k = \frac{Y}{{\sum }_{λ = 400}^{780} \overline{y} ( λ ) E ( λ ) R ( λ )}$$

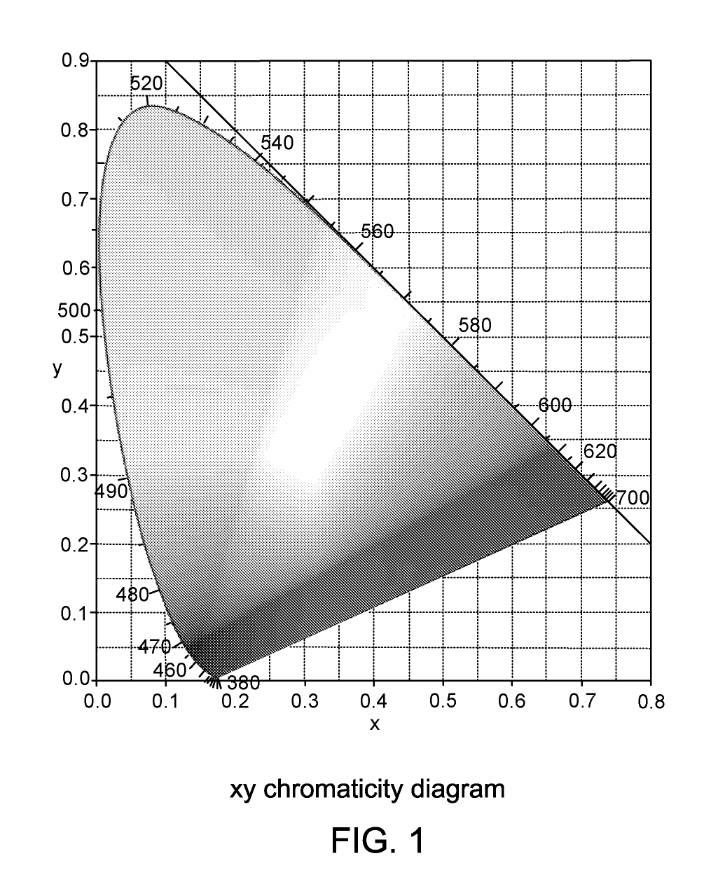

Y represents the brightness of luminance of a color. Thus, if one normalizes the tristimulis X,Y,Z by its sum, one obtains the space xyz which defines the locus color space, as shown in FIG. 1.

$$x = \frac{X}{X + Y + Z}$$

$$y = \frac{Y}{X + Y + Z}$$

$$z = \frac{Z}{X + Y + Z} = 1 - x - y$$

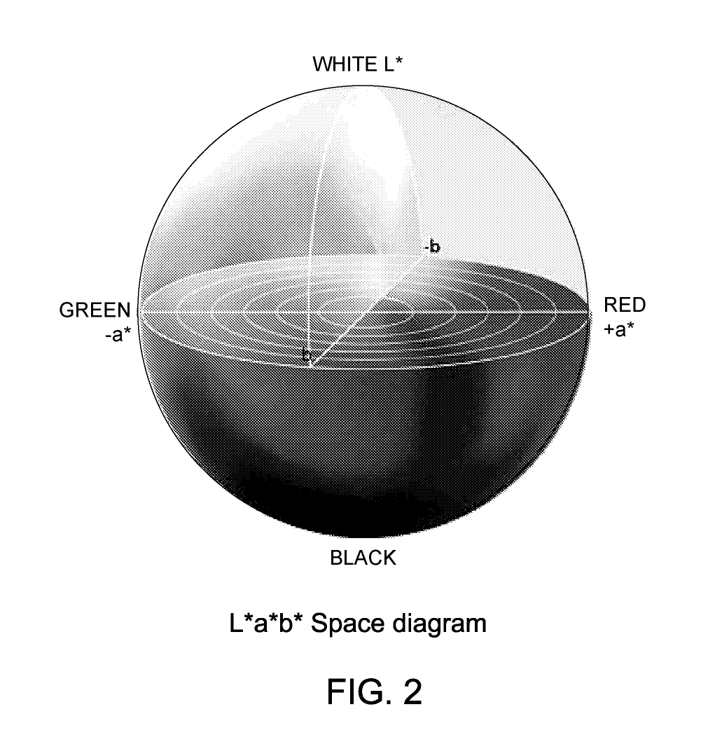

It can be seen from the chromaticity diagram shown in FIG. 1 that it is not linear (i.e., a distance between two points, for instance, in the lower part of the diagram gives more variation in the color than two other points in the upper part (green) of the diagram). To better reflect the perception of the variation in the colors, a different diagram can be used. One such diagram is the L*a*b* space (shown in FIG. 2) that is given by the following transformation:

$${L}^{*} = 116 [ {( \frac{Y}{{Y}_{n}} )}^{1 / 3} - \frac{16}{116} ]$$

$${a}^{*} = 500 [ {( \frac{X}{{X}_{n}} )}^{1 / 3} - {( \frac{Y}{{Y}_{n}} )}^{1 / 3} ]$$

$${b}^{*} = 200 [ {( \frac{Y}{{Y}_{n}} )}^{1 / 3} - {( \frac{Z}{{Z}_{n}} )}^{1 / 3} ]$$

Zₙ,Yₙ,Zₙ are the tristimulis values of the reference white. If

$$\frac{V}{{V}_{n}} \leq 0.008856 ,$$

where V is any of the tristimulis X, Y or Z then replace

$${( \frac{V}{{V}_{n}} )}^{1 / 3} with [ 7.787 ( \frac{V}{{V}_{n}} ) + \frac{16}{116} ]$$

in the equations above.

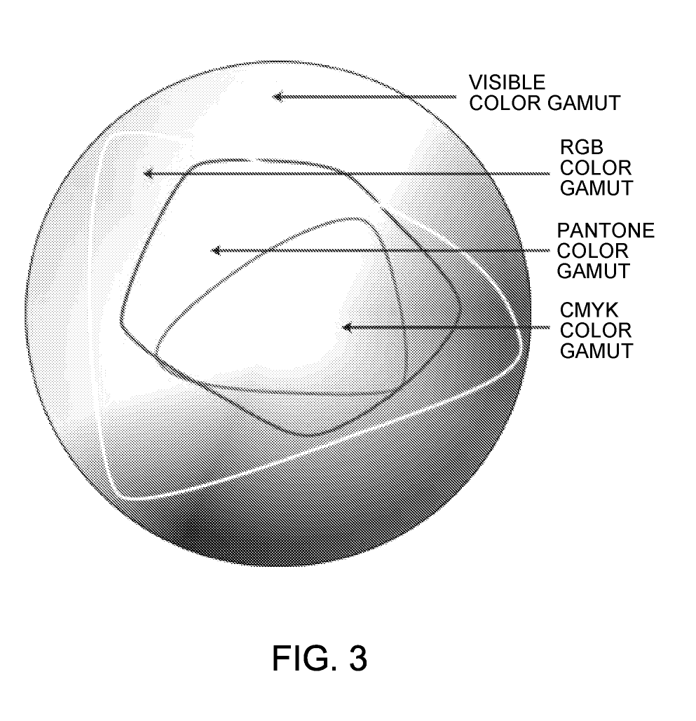

Because of physical differences in how various devices produce colors, each scanner, display, and printer has a different gamut, or range of colors, that it can represent. The RGB color gamut can only display approximately 70% of the colors that can be perceived by the human eye. The CMYK color gamut, which is used in the printers, is much smaller, reproducing about 20% of perceivable colors. The color gamut achieved with premixed inks like the Pantone Matching System (PMS) is also smaller than the RGB gamut. There are many PMS colors, which don't have matches in the CMYK color gamut (as shown in FIG. 3). Although the human eye can see billions of colors, the RGB system covers only about 16 million colors and the CMYK covers about 5-6 thousand colors.

In a currency validation unit, sensors used to obtain spectral responses from an inserted item of currency can have different (e.g., more) sensitivity than the sensitivity of the human eye. Therefore, in practice, the representation of a spectral response in a standard color space is an approximation of the standard color space. As the sensitivities of a sensor system can differ from the sensitivity of the human eye, other color spaces can be defined in a manner similar to how the standard color spaces are defined. A new color space (defined by the sensitivity of the sensor set) can be used for classification in the same manner as a standard color space.

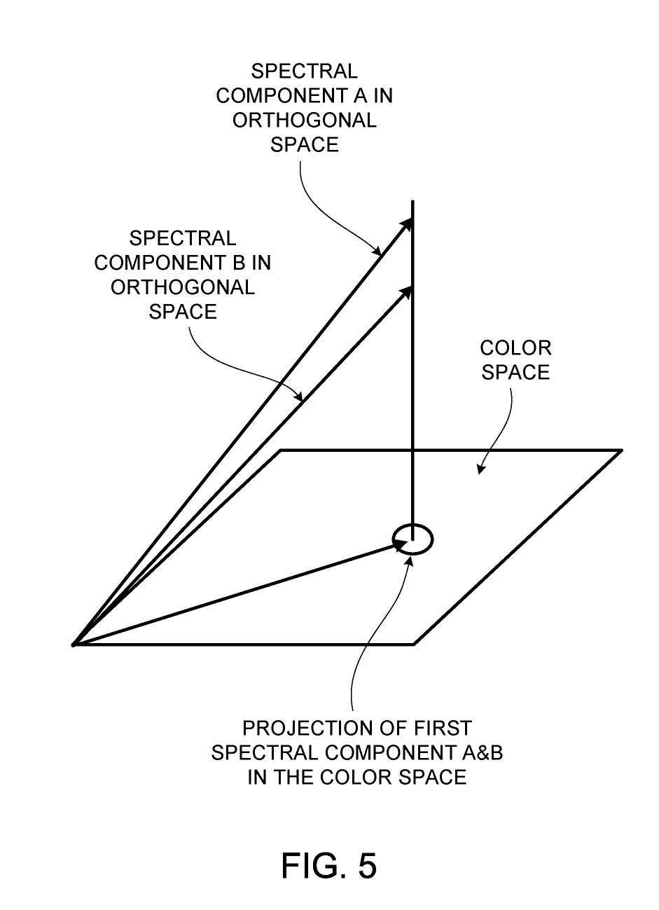

Spectral data can be split into two spaces: fundamental metameric space where all the spectral data represent the same color in the tristimulis space, and the black metameric space, which is orthogonal to the colorimetric space (color space) as shown in FIG. 5. Usually the difference between a genuine item and copies is minimal in a color space because the color reproduction systems conserve color constancy. However a difference between genuine items of currency and non-genuine items of currency can exist in the orthogonal space.

Metameric reflectances R(λ) can be decomposed in two parts: R(λ)=Rₓ(λ)+R₀(λ) where Rₓ(λ) is a particular solution and R₀(λ) is a metameric black, and where λ is a given wavelength.

A light source can described by the spectral power distribution denoted by E(λ). The signal is filtered through three sensors of different spectral sensitivities X₁,X₂,X₃:

$${χ}_{1} = {\sum }_{λ = 400}^{780} R ( λ ) E ( λ ) {X}_{1} ( λ )$$

$${χ}_{2} = {\sum }_{λ = 400}^{780} R ( λ ) E ( λ ) {X}_{2} ( λ )$$

$${χ}_{3} = {\sum }_{λ = 400}^{780} R ( λ ) E ( λ ) {X}_{3} ( λ )$$

χ₁,χ₂,χ₃ are the responses of the three spectral sensitivities X₁,X₂,X₃. Notation using matrices can be given by:

χ=X^{t}D(E)R

where χ=[χ₁,χ₂,χ₃] and X=[X₁,X₂,X₃];
D(E) is the transformation of the illuminant vector into a diagonal matrix and R is the reflectance. If one denotes

Λ=X^{t}D(E),

Λ is called color formation matrix.

Therefore, χ=ΛR. The matrix that minimizes the distance between a spectral response (e.g., reflectance or transmittance) and its projection onto the rows of the color matrix Λ is the orthogonal projector matrix Q given by:

Q=Λ^{t}(ΛΛ^{t})⁻¹Λ,

Q defines a projector into a 3D space. The orthogonal complement is given by:

Q^{⊥}=I−Q

Using the two projectors Q and Q^{⊥} any reflectance (or transmittance) can be decomposed into two parts:

R=QR+Q^{⊥}R

Therefore,

Rₓ=QR

R₀=Q^{⊥R}

When the data are collected in the range of 410-780 nm every 10 nm, the reflectance R is represented by vectors of p dimensions (39 in the example). The fundamental metamer Rₓ is a vector of p−3 dimensions in a space of p dimensions. The metameric black R₀ is a vector of 3 dimensions in a space of p dimensions. A is a 3×p matrix and, the orthogonal projector Q is a p×p matrix. QR is called the fundamental and Q^{⊥}R is called the black component because it is the part of the reflectance (i.e. spectral response) that we cannot see.

The spectra QR and R have the same tristimulis (e.g., the same color), thus they are metamers. But the tristimulis of Q^{⊥}R is zero and, therefore, is called black metamer. In other words:

χ=ΛR=ΛRₓ

and

0=ΛR₀

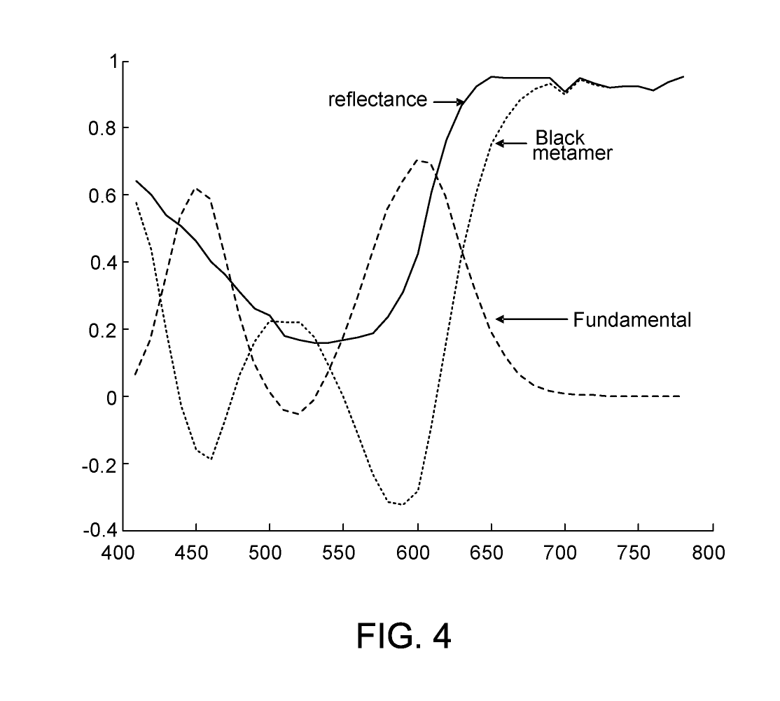

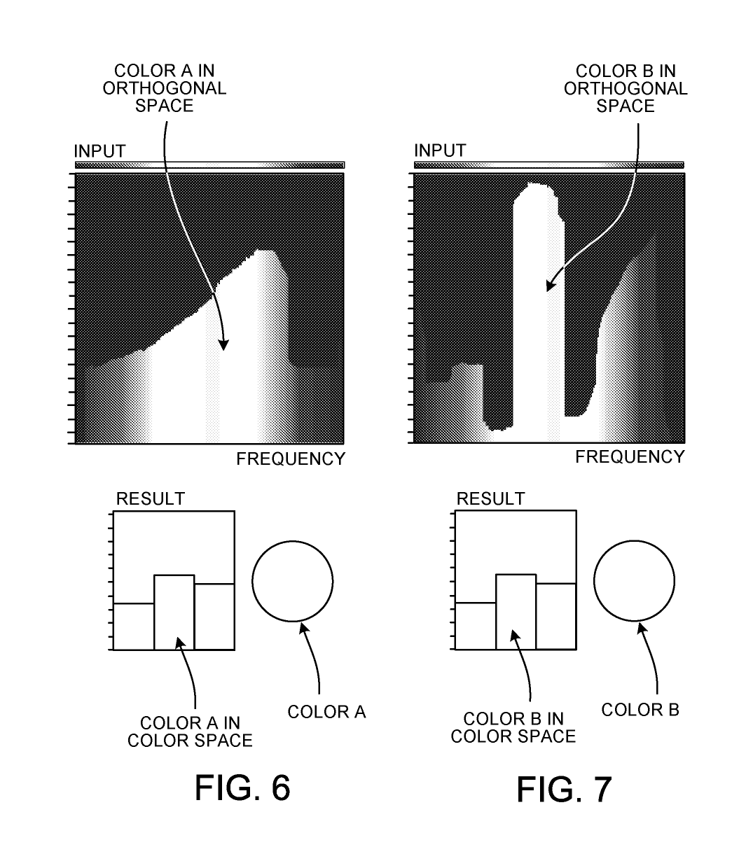

FIG. 4 shows a reflectance R (100) of the magenta patch of the Mackbeth colorchecker. The fundamental metamer Rₓ (200) and the black metamer R₀ (300). It can be seen from FIGS. 6 and 7 that 100 and 200 spectra produce the same color seen by the human eye. The foregoing example uses a spectral response based on reflectance; however, transmission of light through an item of currency can be used as well.

Although the disclosure has used the example of a color space corresponding to the visual perception of the human eye, in other implementations the color space can be established based on the perception of a sensor set. More particularly, the human eye perception is based on the sensitivity of the 3 cones present in a human eye. The same approach can be taken for a sensor set each having a particular sensitivity such that the color space is established based on the sensitivity of the sensors in the sensor set (e.g., 4 sensors) each having a sensitivity in a particular wavelength band. Thus, the wavelength band can be a range within the non-visible spectrum.

The application of a color space being established using a sensor set allows for a corresponding orthogonal space to be established such that discrimination of colors can be made using a non-visible color space and the corresponding orthogonal space.

In some implementations, a known item of currency is evaluated using a validation unit. The validation unit obtains spectral response information from the known item of currency to be used in a reference data set to later discriminate items of currency. The spectral response information of at least one known item of currency can be obtained from equipment similar to the validation unit and the results can be stored within the memory unit of the validation unit.

When spectral response information is obtained from a known item of currency, this information can be further evaluated using a color space (e.g., CIE YXZ or CIE Lab spaces or a non-visible color space). Analysis of the spectral response information of a known item of currency in one of the aforementioned spaces (e.g., CIE XYZ or CIE Lab), allows for a determination of at least one spectral component response. In some implementations, the spectral response analyzed in one of the CIE spaces allows for the determination of a fundamental metamer (i.e., a first component spectral response) and a black metamer (i.e., a second component spectral response). Multiple known items of currency can be analyzed in the manner disclosed to create a group of reference data sets for various denominations of currency. In this manner, an unknown item of currency can be determined to belong to any one of the known items of currency included within the group.

In some implementations, a group of known items of currency are represented by their respective spectral component responses (e.g., fundamental metamer and black metamer). In further implementations, the respective spectral component response are stored within a validation unit to be used for discriminating items of currency. In particular, an unknown item of currency is evaluated using the validation unit. The validation unit is configured to obtain respective spectral component responses from an inserted unknown item of currency. The validation unit is further configured to compare the information about the inserted unknown item of currency with information about at least one known item of currency within a group of known items of currency stored in the memory unit. An inserted item of currency can be determined to belong to a given denomination (or class), as represented by a known item of currency, if the fundamental metamer (i.e., first component spectral response) falls within a predetermined tolerance of the known item of currency. In some implementations, the validation unit is further configured to determine that an inserted unknown item of currency is a genuine item of currency (of the denomination previously determined) if the comparison of the black metamer of the unknown item of currency falls within a predetermined tolerance of the black metamer of the known item of currency (having a specific denomination).

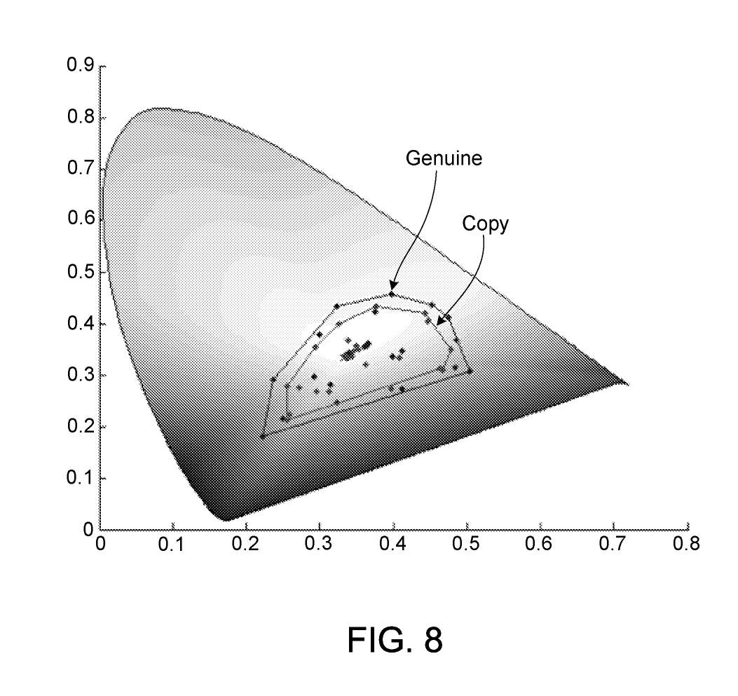

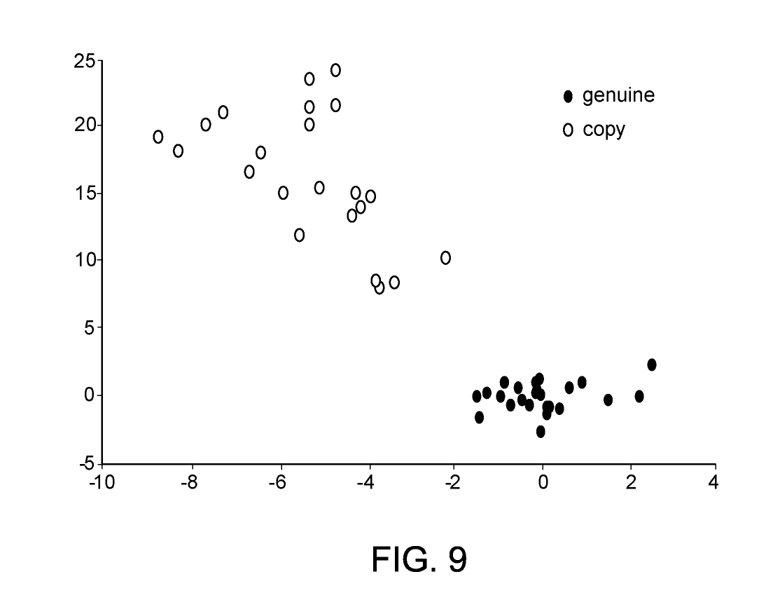

FIG. 8 shows the comparison of a first component spectral response (fundamental metamer) of a genuine item of currency (of a specific denomination) and a non-genuine item of currency in a color space (e.g., CIE XYZ or CIE Lab). Both the known genuine item of currency (of a specific denomination) and the unknown item of currency exhibit similar first component spectral responses. As the first component spectral of the unknown item of currency exhibits similar first component spectral responses as the known genuine item of currency, it can be determined that the unknown item of currency is a member of the denomination of the known genuine item of currency. As shown in FIG. 9, the second component spectral responses (black metamers) of the unknown item of currency are different from the second component spectral responses of the known genuine item of currency. It is, therefore, useful to use the second component spectral responses of the known genuine and unknown items of currency to discriminate genuine items of currency from non-genuine items of currency.

In some implementations, the classification (or discrimination) of an unknown item of currency can be accomplished using both spectral component responses together. Although the disclosure has presented implementations in which the first spectral component response and second spectral component response are evaluated separately, or used for different evaluations, each component response comparison can be used to discriminate between classes of items of currency either independently or together.

The spectral component response can be used as inputs to a classification technique. Various classification techniques exists; an example of one such technique is disclosed in a U.S. patent application, entitled “CURRENCY DISCRIMINATION” (Ser. No. 61/084,358), and incorporated herein in its entirety. The inputs to the reduction technique disclosed in that application can be the spectral component response described in the present disclosure.

In some implementations, a group of known items of currency are used to classify an unknown item of currency. For each known item of currency, the spectral component response can be established using a color space best suited for that particular item of currency. For example, to classify an unknown item of currency as being a member of the class represented by a US $10 banknote, the CIE XYZ color space can be used. Furthermore, to classify an unknown item of currency as being a member of the class represented by a 5 Euro banknote, the CIE Lab color space can be used. In some implementations, each respective known item of currency is evaluated using a color space different from the color space used to evaluate other known items of currency (e.g., $10 notes vs. $20 notes).

The validation unit can be adapted to store spectral component responses for multiple known items of currency in which at least one of the other known items of currency uses a color space different from at least one other known item of currency for classification.

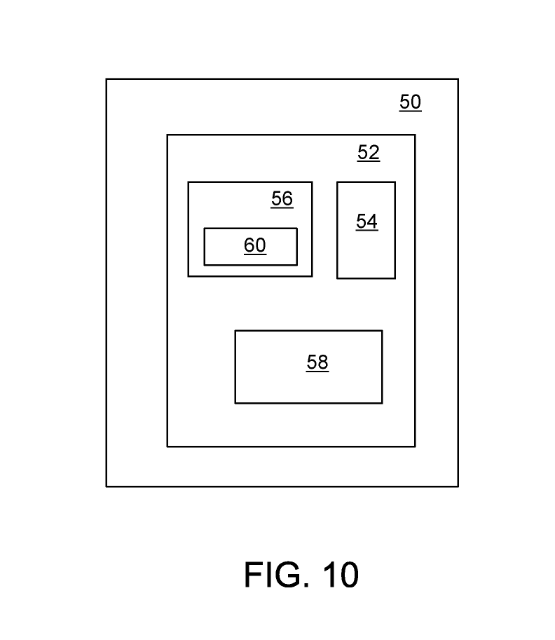

As illustrated in FIG. 10, in some implementations, an automated transaction machine 50 includes a validation unit 52 for discriminating between an unknown item of currency and at least one known denomination (or class). The validation unit can include a sensing unit 54, memory unit 56 and a processing unit 58 such as a microprocessor. The validation unit stores spectral response information 60 of at least one known item of currency having at least one component response for comparison with an inserted item of currency.

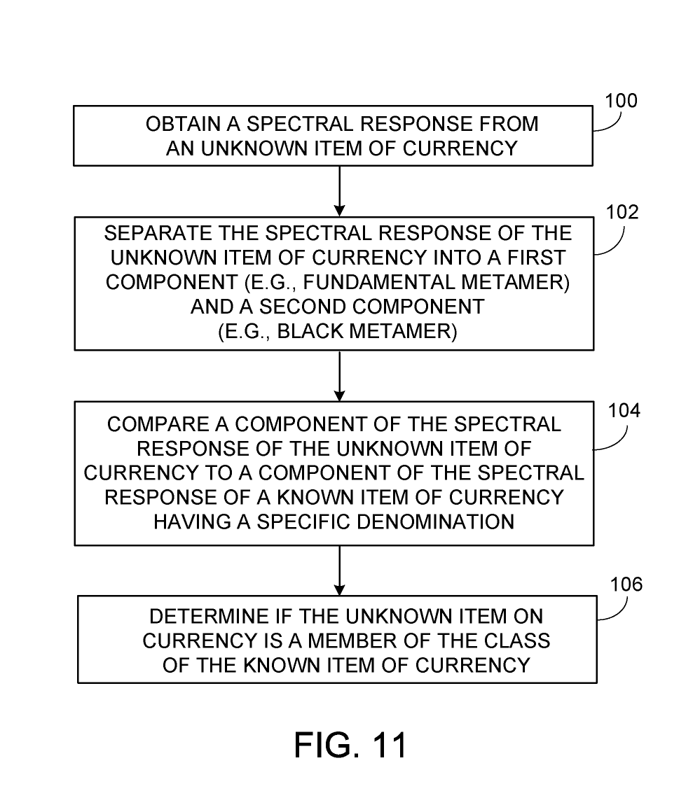

As illustrated in FIG. 11, the currency validator can be arranged to obtain a spectral response from an unknown item of currency (block 100), separate the spectral response of the unknown item of currency into a first component (e.g., fundamental metamer) and a second component (e.g., black metamer) (block 102), and compare at least one component of the spectral response of the unknown item of currency to at least one component of the spectral response of at least one known item of currency having a specific denomination (block 104). The currency validator determines if the unknown item of currency is a member of the class of the at least one known item of currency (block 106). For example, the unknown item of currency can be determined to be a member of the class of the at least one known item of currency if the at least one component response of the unknown item of currency falls within a predefined tolerance of the at least one component response of the at least one known item of currency based on the comparison.

Other implementations are within the scope of the claims.

1. A method for comparing an unknown item of currency to at least one known item of currency by evaluating the spectral response of the unknown item of currency, the method comprising:
obtaining a spectral response from the unknown item of currency;
separating the spectral response of the unknown item of currency into a first component and a second component;
comparing at least one component of the spectral response of the unknown item of currency to at least one component of the spectral response of at least one known item of currency having a specific denomination; and
determining if the unknown item of currency is a member of the class of the at least one known item of currency, wherein the unknown item of currency is determined to be a member of the class of the at least one known item of currency if the at least one component response of the unknown item of currency falls within a predefined tolerance of the at least one component response of the at least one known item of currency when compared thereto.

2. A method according claim 1 wherein the first spectral component is a fundamental metamer.

3. A method according to claim 1 wherein the second spectral component is a black metamer.

4. A method according to claim 1 including evaluating the spectral response using a color space.

5. A method according to claim 4 wherein a second space is established orthogonal to the color space.

6. A method according to claim 4 wherein the color space is the CIE XYZ space.

7. A method according to claim 4 wherein the color space is the CIE Lab space.

8. A method according to claim 1 wherein the method is performed by a currency validation unit.

9. An apparatus for discriminating items of currency comprising a validation unit arranged to obtain spectral response information from an inserted unknown item of currency, the validator including:
a memory unit storing spectral response information of at least one known item of currency having at least one component response;
a sensing unit to obtain spectral information from the inserted unknown item of currency; and
a processing unit arranged to obtain at least one spectral component response of the inserted unknown item of currency from the spectral response information of the inserted unknown item of currency;
wherein the validation unit is arranged to compare the at least one component response of an inserted unknown item of currency to an at least one component response of the at least one known item of currency, and to determine the inserted unknown item of currency to be a member of the class of the at least one known item of currency if the comparison of the at least one component response of the inserted unknown item of currency falls within a predetermined tolerance of the at least one component response of the at least one known item of currency stored in the memory unit.

10. An apparatus according to claim 9 wherein the memory unit is arranged to store a second spectral component response of the at least one known item of currency.

11. An apparatus according to claim 9 wherein the validation unit is further arranged to obtain a second spectral component response of the inserted unknown item of currency from the spectral response information of the inserted unknown item of currency.

12. An apparatus according to claim 9 wherein the first component spectral response is the fundamental metamer.

13. An apparatus according to claim 10 wherein the second component spectral response is the black metamer.

14. An apparatus according to claim 9 wherein the validation unit is further arranged to determine the spectral response using the CIW XYZ space.

15. An apparatus according to claim 9 wherein the validation unit is further arranged to determine the spectral response using the CIE Lab space.
